(19) United States
(12) Patent Application Publication
(10) Pub. No.: US 2025/0091918 A1
(43) Pub. Date: Mar. 20, 2025

(54) Compositions and Methods for Mitigating Standing Water and Controlling Water-Breeding Pests

(71) Applicant: LOCUS SOLUTIONS IPCO, LLC, SOLON, OH (US)

(72) Inventor: Sean FARMER, Ft. Lauderdale, FL (US)

(21) Appl. No.: 18/248,438

(22) PCT Filed: Mar. 13, 2023
(86) PCT No.: PCT/US2023/015074

§ 371 Date: Apr. 10, 2023

Related U.S. Application Data
(60) Provisional application No. 63/319,490, filed on Mar. 14, 2022.

(51) Int. Cl. C02F 1/54; A01N 63/22; A01N 63/32; A01P 21/00; C02F 103/00; E02D 3/00

(52) U.S. Cl. CPC C02F 1/547; A01N 63/22; A01N 63/32; A01P 21/00; E02D 3/00; C02F 2103/007; C02F 2305/04

(57) ABSTRACT

The subject invention provides compositions for treating standing water, such as retention ponds and puddles, as well as soils prone to flooding and pooling. More specifically, the subject invention provides microbe-derived compositions as well as their use in preventing and/or mitigating, i.e., draining, undesirable standing water and/or problems associated with standing water, such as mosquitos and algal growth. Advantageously, the compositions and methods of the subject invention can be used as environmentally friendly, non-toxic and cost-effective solutions for water-use efficiency, soil health, and pest control.

### CROSS-REFERENCE TO RELATED APPLICATION

This application claims priority to U.S. Provisional Patent Application No. 63/319,490, filed Mar. 14, 2022, which his incorporated herein by reference in its entirety.

### BACKGROUND OF THE INVENTION

Soil is a complex mixture of minerals, gases, liquids, organic matter and microorganisms. The specific composition of a particular type of soil varies based on factors such as, for example, human activity, geographic location and climate. The health of soil can also depend on these factors. Degradation, compaction, hydrophobicity and inefficient water and nutrient transport are all examples of problems that can arise in certain soils, each of which can lead to negative environmental impacts as well as negative outcomes for farms, golf courses and athletic fields, lawns, areas of development, and pastures.

Compaction, for example, can be caused by changes in soil particle distribution, organic matter content, mineralogy and water content, where soil particles become pressed together, thereby reducing the pore space in between. Well-sorted, fine sandy loams and loamy fine sands with a high fine sand fraction and low carbon content are particularly susceptible to compaction.

Compaction can also be caused by, for example, livestock trampling, use of heavy machinery, certain irrigation practices, and poorly managed tilling practices. Over time, compaction leads to physical soil degradation, reduced microbial populations, reduced soil organic composition (SOC), and modification of the size, structure and number of pores. In turn, soil strength increases, along with bulk density, while conductivity, permeability and diffusivity of water and air are reduced. Soil layers with high penetration resistance decrease rooting depth and density, which lead to a reduction in plant nutrient uptake, water uptake and water-use efficiency. Furthermore, inefficient water and nutrient transport can cause flooding and pooling of water (e.g., standing or stagnant water), as well as runoff of phosphates and nitrates, leading to, for example, harmful algal blooms.

Soil hydrophobicity is another problem that can occur in soils. Soils can be naturally hydrophobic in nature, and this is often exacerbated when the soil is left to dry for an extended time or has a high organic content. Fires can also induce or intensify soil water repellency as hydrophobic substances in the soil and litter are volatilized, pyrolyzed, and redistributed deeper into the soil profile.

The hydrophobic nature of soil can limit the penetration and infiltration of irrigation-based applications and rainwater. Thus, soil hydrophobicity can also lead to flooding, water pooling, evaporation and surface run-off, which has a direct consequence on water-use efficiency and plant growth through restriction of water infiltration and supply to the root zone of plants. Furthermore, water pooling can result in inoculation and growth of undesirable life forms, such as algae and mosquitos.

Mosquitos, in particular, are not only a nuisance as biting insects, but have the potential to cause other harmful and widespread consequences. Mosquitos serve as vectors for the spread of a multitude of diseases, which can severely impact humans, pets, and livestock. For example, mosquitos from the Aedes genus are responsible for the transmission of several dangerous human viruses, including those that cause malaria, dengue fever, yellow fever, chikungunya, and most recently, zika.

Areas most conducive to mosquito population growth and survival are those with hot and humid climates, though mosquitos can be found in almost any habitat where stagnant water is abundant. This is because a major portion of the mosquito life cycle occurs in water. Females of container-breeding species will lay their eggs on the surfaces of man-made containers, puddles, swamps, or small pools. Others will lay their eggs in damp or dry soil to be flooded by rising water. When the eggs hatch in the water, the young mosquitos remain in the water for nine to fourteen days, through the larval and pupal stages of development. Only when they reach adulthood do mosquitos finally leave the water.

As a result of the potential dangers posed by mosquito bites, monitoring, controlling, and/or changing the behavior of mosquito populations is essential to helping prevent widespread transmission of mosquito-borne diseases. For example, draining or preventing sources of standing water can help eliminate mosquito breeding areas. Additionally, introduction of traps, protection of natural mosquito predators or enemies, as well as dispersion of insecticides into mosquito habitats, can help reduce population numbers. However, widespread insecticide use can cause persistence of toxic chemicals in the environment and may harm beneficial species as a side-effect.

The economic costs and environmental impacts of poor soil health and low water use efficiency are a continued burden for farmers, landscapers, homeowners, and herders. The risks of mosquito-born illnesses are an additional factor contributing to the need for improved, safe approaches to addressing soil and water management, especially in climates where mosquitos thrive.

### BRIEF SUMMARY OF THE INVENTION

The subject invention provides compositions and methods for treating standing water, such as retention ponds and puddles, as well as soils prone to flooding and pooling. More specifically, the subject invention provides microbe-derived compositions as well as their use in preventing and/or mitigating, e.g., draining, undesirable standing water and/or problems associated with standing water, such as mosquitos and algal growth. Advantageously, the compositions and methods of the subject invention can be used as environmentally friendly, non-toxic and cost-effective solutions for improving water-use efficiency, enhancing soil health, and controlling pests.

In certain embodiments, the subject invention provides water treatment compositions comprising a surface-active molecule. The water treatment composition can serve multiple purposes, which include:
a) a wetting agent for facilitating the drainage of pooling water into soil;
b) a prophylactic treatment for enhancing the wettability and drainage of soil prior to contact with water such that pooling and flooding are prevented; and
c) a pest control agent, for controlling mosquitos, mosquito larvae and/or algae that are present in stagnant water.

Thus, in certain embodiments, methods are provided wherein the water treatment is applied to natural and artificial sources of standing water and/or soil. In some embodiments, the methods comprise applying the composition to water that is pooling on top of soil, a container of water, such as a water trough, or a body of water, such as a pond. In some embodiments, the methods comprise applying the composition to soil prior to the soil being contacted with irrigation water or rainfall.

Advantageously, in addition to mitigating standing water and/or controlling pests, the methods and compositions are, in some embodiments, effective for improving water-use efficiency and irrigation of soil in a wide variety of conditions, including, for example, compacted soil, arid soil, eroded soil, nutrient-depleted soil, water-logged soil, fire-damaged soil, hydrophobic soil, and/or soil with plants growing therein.

In preferred embodiments, the surface-active molecule of the subject invention is a microbial-derived biosurfactant. The biosurfactant can be applied in purified and/or crude form. Crude form biosurfactants can comprise, for example, biosurfactants and other products of cellular growth, including fermentation medium resulting from cultivation of a biosurfactant-producing microbe.

Biosurfactants according to the subject methods can be selected from, for example, low molecular weight glycolipids (e.g., sophorolipids, cellobiose lipids, rhamnolipids, mannosylerythritol lipids and trehalose lipids), lipopeptides (e.g., surfactin, iturin, fengycin, arthrofactin and lichenysin), flavolipids, phospholipids (e.g., cardiolipins), fatty acid esters, and high molecular weight polymers such as lipoproteins, lipopolysaccharide-protein complexes, and polysaccharide-protein-fatty acid complexes.

In certain specific embodiments, the biosurfactant is a sophorolipid (SLP), such as, for example, a lactonic SLP, an acidic SLP, an amino acid-SLP conjugate, a salt-form SLP, or a derivative of any of these.

In certain embodiments, the water treatment composition can comprise additional substances, such as, for example, carriers, microbial inoculants, pH adjusters, additional pesticides, herbicides, fertilizers, mineral sources, plant seeds, dyes, stabilizers, emulsifiers, prebiotics and/or polymers.

The composition can be applied in combination with an aqueous fluid and administered to the water and/or soil. Additionally, or alternatively, the composition can be applied as a dry form powder or granule, which when mixed with water, activates the surface active molecule within the composition.

In certain embodiments, the water treatment composition is particularly helpful for reducing surface and/or interfacial tension between water and soil, as well as increasing porosity of compacted soils, due to its nanoparticle micelle size. The ultra-small micelle size of the irrigation additive allows water to penetrate into micro- and nano-sized pores in hard and tightly packed soils, thereby loosening the pores and allowing for increased air, nutrient and water flow.

In certain embodiments, the water treatment composition lowers the surface tension of water, thereby controlling mosquito larvae and causing adult mosquitos to sink.

In certain embodiments, the water treatment composition has biocidal properties, thereby facilitating the control of algal growth.

The compositions and methods of the subject invention can be useful for, e.g., farms, pastures, fields, lawns, gardens, golf courses, parks, swamps, ditches, gutters, and any location that is prone to flooding or puddles, has open containers that collect water, or has a body of standing or stagnant water. Advantageously, the compositions and methods of the subject invention provide “green” alternatives to pest control while improving water-use efficiency and soil health.

### DETAILED DESCRIPTION OF THE INVENTION

The subject invention provides microbe-derived compositions as well as methods of their use in preventing and/or mitigating, e.g., draining, undesirable standing water and/or problems associated with standing water, such as mosquitos and algal growth. Advantageously, the compositions and methods of the subject invention can be used as environmentally friendly, non-toxic and cost-effective solutions for improving water-use efficiency, enhancing soil health, and controlling pests.

### Selected Definitions

As used herein, “agriculture” means the cultivation and breeding of plants for food, fiber, biofuel, medicines, cosmetics, supplements, ornamental purposes and other uses. According to the subject invention, agriculture can also include horticulture, landscaping, gardening, plant conservation, forestry and reforestation, pasture and prairie restoration, orcharding, arboriculture, and agronomy. Further included in agriculture are the care, monitoring and maintenance of soil.

As used herein, a “broth,” “culture broth,” or “fermentation broth” refers to a culture medium comprising at least nutrients and microorganism cells.

As used herein, the term “carbon use efficiency” or “CUE” refers to a generalized measure of the efficiency by which microbes allocate carbon taken up towards growth and biomass production versus respiration. CUE can be calculated as growth (biomass production) over the sum of CO₂ production/emissions and growth. Microorganisms are often categorized as “low CUE” or “high CUE,” where a CUE greater than 0.50 is considered high, and a CUE lower than 0.50 is considered low.

Unless the context requires otherwise, the phrases “fermenting,” “fermentation process” or “fermentation reaction” and the like, as used herein, are intended to encompass both the growth phase and product biosynthesis phase of the process.

As used herein, an “isolated” or “purified” compound is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. “Isolated” in the context of a microbial strain means that the strain is removed from the environment in which it exists in nature. Thus, the isolated strain may exist as, for example, a biologically pure culture, or as spores (or other forms of the strain) in association with a carrier.

As used herein, a “biologically pure culture” is a culture that has been isolated from materials with which it is associated in nature. In a preferred embodiment, the culture has been isolated from all other living cells. In further preferred embodiments, the biologically pure culture has advantageous characteristics compared to a culture of the same microbe as it exists in nature. The advantageous characteristics can be, for example, enhanced production of one or more growth by-products.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

As used herein, the terms “enhancing,” “improving” and “increasing” can be used interchangeably.

A “metabolite” refers to any substance produced by metabolism (e.g., a growth by-product) or a substance necessary for taking part in a particular metabolic process. A metabolite can be an organic compound that is a starting material, an intermediate in, or an end product of metabolism. Examples of metabolites include, but are not limited to, biosurfactants, biopolymers, enzymes, acids, solvents, alcohols, proteins, vitamins, minerals, microelements, and amino acids.

The subject invention utilizes “microbe-based compositions,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore or conidia form, in hyphae form, in any other form of propagule, or a mixture of these. The microbes may be planktonic or in a biofilm form, or a mixture of both. The by-products of growth may be, for example, metabolites, cell membrane components, proteins, and/or other cellular components. The microbes may be intact or lysed. In preferred embodiments, the microbes are present, with growth medium in which they were grown, in the microbe-based composition. The microbes may be present at, for example, a concentration of at least 1×10⁴, 1×10⁵, 1×10⁶, 1×10⁷, 1×10⁸, 1×10⁹, 1×10¹⁰, 1×10¹¹, 1×10¹² or 1×10¹³ or more CFU per gram or per ml of the composition.

The subject invention further provides “microbe-based products,” which are products that are to be applied in practice to achieve a desired result. The microbe-based product can be simply a microbe-based composition harvested from a microbe cultivation process. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, the term “plant” includes, but is not limited to, any species of woody, ornamental or decorative, crop or cercal, fruit plant or vegetable plant, flower or tree, macroalga or microalga, phytoplankton and photosynthetic algae (e.g., green algae Chlamydomonas reinhardtii). “Plant” also includes a unicellular plant (e.g., microalga) and a plurality of plant cells that are largely differentiated into a colony (e.g., volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop or pasture.

As used herein, “crop plants” refer to any species of plant or alga, grown for profit and/or for sustenance for humans, animals or aquatic organisms, or used by humans (e.g., textile, cosmetics, and/or drug production), or viewed by humans for pleasure (e.g., flowers or shrubs in landscaping or gardens) or any plant or alga, or a part thereof, used in industry, commerce or education. Crop plants can be plants that can be obtained by traditional breeding and optimization methods or by biotechnological and recombinant methods, or combinations of these methods, including the transgenic plants and the plant varieties.

All plants and plant parts can benefit from the subject invention. In this context, plants are understood as meaning all plants and plant populations such as desired and undesired wild plants or crop plants (including naturally occurring crop plants).

Plant tissue and/or plant parts are understood as meaning all aerial and subterranean parts and organs of the plants such as shoots, leaves, flowers, roots, needles, stalks, stems, fruits, seeds, tubers and rhizomes. The plant parts also include crop material and vegetative and generative propagation material, for example cuttings, tubers, rhizomes, slips and seeds.

As used herein “preventing” or “prevention” of a situation or occurrence means delaying, inhibiting, suppressing, forestalling, and/or minimizing the onset, extensiveness or progression of the situation or occurrence. Prevention can include, but does not require, indefinite, absolute or complete prevention, meaning it may still develop at a later time. Prevention can include reducing the severity of the onset of such a situation or occurrence, and/or stalling its development to a more severe or extensive situation or occurrence.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduction” refers to a negative alteration, and the term “increase” refers to a positive alteration, wherein the negative or positive alteration is at least 0.25%, 0.5%, 1%, 5%, 10%, 15%, 20%, 25%, 30%, 35%, 40%, 45%, 50%, 55%, 60%, 70%, 75%, 80%, 85%, 90%, 95%, or 100%.

As used herein, “reference” refers to a standard or control condition.

As used herein, a “soil amendment” or a “soil conditioner” is any compound, material, or combination of compounds or materials that are added into soil to enhance the properties of the soil and/or rhizosphere. Soil amendments can include organic and inorganic matter, and can further include, for example, fertilizers, pesticides and/or herbicides. Nutrient-rich, well-draining soil is essential for the growth and health of plants, and thus, soil amendments can be used for enhancing the plant biomass by altering the nutrient and moisture content of soil. Soil amendments can also be used for improving many different qualities of soil, including but not limited to, soil structure (e.g., preventing compaction); improving the nutrient concentration and storage capabilities; improving water retention in dry soils; and improving drainage in waterlogged soils.

As used herein, “surfactant” refers to a compound that lowers the surface tension (or interfacial tension) between phases. Surfactants act as, e.g., detergents, wetting agents, emulsifiers, foaming agents, and dispersants. A “biosurfactant” is a surfactant produced by a living organism.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially” of the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof. All references cited herein are hereby incorporated by reference in their entirety.

### Compositions and Methods for Mitigating Standing Water and Controlling Pests

In certain embodiments, the subject invention provides water treatment compositions comprising a surface-active molecule. The water treatment composition can serve multiple purposes, which include:
d) a wetting agent for facilitating the drainage of pooling water into soil;
e) a prophylactic treatment for enhancing the wettability and drainage of soil prior to contact with water such that pooling and flooding are prevented; and
f) a pest control agent, for controlling mosquitos, mosquito larvae and/or algae that are present in stagnant water.

Thus, in certain embodiments, methods are provided wherein the water treatment is applied to standing water and/or soil.

The compositions and methods of the subject invention can be useful for, e.g., farms, pastures, fields, lawns, gardens, golf courses, parks, swamps, ditches, gutters, and any location that is prone to flooding or puddles, has open containers that collect water, or has a body of standing or stagnant water. In certain embodiments, in addition to mitigating standing water and/or controlling pests, the methods and compositions are effective for improving water-use efficiency and irrigation of soil in a wide variety of conditions, including, for example, compacted soil, arid soil, eroded soil, nutrient-depleted soil, water-logged soil, fire-damaged soil, hydrophobic soil, and/or soil with plants growing therein.

In preferred embodiments, the surface-active molecule of the subject invention is a microbial-derived biosurfactant. The biosurfactant can be applied in purified and/or crude form. Crude form biosurfactants can comprise, for example, biosurfactants and other products of cellular growth, including fermentation medium resulting from cultivation of a biosurfactant-producing microbe.

Biosurfactants form an important class of secondary metabolites produced by a variety of microorganisms such as bacteria, fungi, and yeasts. As amphiphilic molecules, microbial biosurfactants reduce the surface and interfacial tensions between the molecules of liquids, solids, and gases. Furthermore, the biosurfactants according to the subject invention are biodegradable, have low toxicity, are effective in solubilizing and degrading insoluble compounds in soil and can be produced using low cost and renewable resources. They can inhibit adhesion of undesirable microorganisms to a variety of surfaces, prevent the formation of biofilms, disrupt microbial cell walls, and can have powerful emulsifying and demulsifying properties. Furthermore, the biosurfactants can also be used to improve wettability and to achieve even solubilization and/or distribution of fertilizers, nutrients, and water in the soil.

Biosurfactants according to the subject methods can be selected from, for example, low molecular weight glycolipids (e.g., sophorolipids, cellobiose lipids, rhamnolipids, mannosylerythritol lipids and trehalose lipids), lipopeptides (e.g., surfactin, iturin, fengycin, arthrofactin and lichenysin), flavolipids, phospholipids (e.g., cardiolipins), fatty acid esters, and high molecular weight polymers such as lipoproteins, lipopolysaccharide-protein complexes, and polysaccharide-protein-fatty acid complexes.

In certain specific embodiments, the biosurfactant is a sophorolipid (SLP), such as, for example, a lactonic SLP, an acidic SLP, an amino acid-SLP conjugate, a salt-form SLP, or a derivative of any of these.

As used herein, the term “sophorolipid,” “sophorolipid molecule,” “SLP” or “SLP molecule” includes all forms, and isomers thereof, of SLP molecules, including, for example, acidic (linear) SLP (ASL) and lactonic SLP (LSL). Further included are mono-acetylated SLP, di-acetylated SLP, esterified SLP, SLP with varying hydrophobic chain lengths, cationic and/or anionic SLP with fatty acid-amino acid complexes attached, esterified SLP, SLP-metal complexes, salt form SLP, SLP amino alcohols, SLP with carbonyl groups removed from the aliphatic chain, and other, including those that are and/or are not described within in this disclosure.

In preferred embodiments, the SLP molecules according to the subject invention are represented by General Formula (1) and/or General Formula (2), and include 30 or more types of structural homologues having different fatty acid chain lengths (R³), and, in some instances, having an acetylation or protonation at R¹ and/or R².

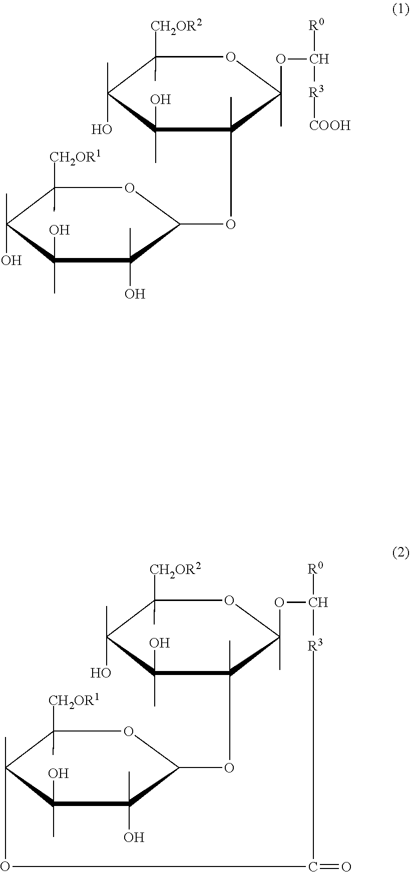

In General Formula (1) or (2), R⁰ can be, for example, either a hydrogen atom or a methyl group. R¹ and R² can each independently be, for example, a hydrogen atom or an acetyl group. R³ can be, for example, a saturated aliphatic hydrocarbon chain, or an unsaturated aliphatic hydrocarbon chain having at least one double bond, and may have one or more Substituents.

Non-limiting examples of the Substituents include halogen atoms, hydroxyl, lower (C1-6) alkyl groups, halo lower (C1-6) alkyl groups, hydroxy lower (C1-6) alkyl groups, halo lower (C1-6) alkoxy groups, and others. R³ typically can have 9 to 20 carbon atoms.

SLP are typically produced by yeasts, such as Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. SLP have environmental compatibility, high biodegradability, low toxicity, high selectivity and specific activity in a broad range of temperature, pH and salinity conditions.

In preferred embodiments, the surface active agent of the subject composition has a micelle size less than 100 nm, less than 75 nm, less than 50 nm, and more preferably less than 25 nm. In certain embodiments, the micelle size is less than 10 nm, less than 8 nm, or less than 5 nm.

In certain embodiments, the surface active molecule having small micelle size (e.g., less than 20 nm) or, more preferably, an ultra-small micelle size (e.g., less than 10 nm), is particularly helpful for reducing surface and/or interfacial tension between water and soil, as well as increasing porosity of compacted soils, due to its nanoparticle micelle size. The ultra-small micelle size of the irrigation additive allows water to penetrate into micro- and nano-sized pores in hard and tightly packed soils, thereby loosening the pores and allowing for increased air, nutrient and water flow.

In certain embodiments, the irrigation additive can comprise additional substances, such as, for example, carriers, pH adjusters, pesticides, herbicides, fertilizers, microbial inoculants, mineral sources, soil amendments, soil conditioners, plant seeds, dyes, stabilizers, emulsifiers, prebiotics, and/or polymers.

As used herein, “applying” a composition or product to a site refers to contacting a composition or product with a site such that the composition or product can have an effect on that site. The mode of application depends upon the formulation of the composition, and can include, for example, spraying, pouring, sprinkling, injecting, spreading, mixing, dunking, fogging and misting. The compositions of the subject invention can be formulated as, for example, liquids, dry and/or wettable powders, powders, dusts, granules, pellets, emulsions, microcapsules, steaks, oils, gels, pastes and/or aerosols.

In some embodiments, the methods comprise applying the water treatment composition to water that is pooling on top of soil to improve the drainage of water into the soil.

In some embodiments, the methods comprise applying the composition to soil prior to the soil being contacted with irrigation water or rainfall.

In some embodiments, the methods comprise applying the composition to a container of standing water, such as a water trough, or a body of standing water, such as a pond or puddle that has formed on soil or a non-soil surface.

The composition can be pre-mixed with irrigation fluids, and/or the composition(s) can be applied to water and/or soil surfaces, with or without water, where the beneficial effect of the soil application can be activated by rainfall, sprinkler, flood, drip or other forms of irrigation.

In one embodiment, the method can comprise administering the composition(s) into an irrigation system used for supplying water, fertilizers, pesticides or other liquid compositions. Thus, the composition can be applied via, for example, soil injection, soil drenching, using a center pivot irrigation system, with a spray, with micro-jets, with drench sprayers, with boom sprayers, with sprinklers and/or with drip irrigators. Advantageously, the method is suitable for treating hundreds or more acres of land.

In one embodiment, wherein the method is used in a smaller scale setting, the method can comprise spraying a site with the composition using a handheld lawn and garden sprayer, or simply pouring the composition into soil or water using a vessel or a watering can.

Advantageously, in certain embodiments, the water treatment composition helps reduce the surface and/or interfacial tension between the water and soil contents, thereby providing improved dispersion, penetration and/or percolation of water and nutrients into the soil, and reduced flooding and pooling of water on and in soil, thereby reducing evaporation, runoff and waterlogging.

Additionally, in certain embodiments, the water treatment composition helps loosen hard or compacted soils via penetration of tight soil pores, resulting in increased soil porosity and aeration. Advantageously, this can increase the space for root growth and water holding capacity within the soil.

Furthermore, in certain embodiments, the water treatment composition lowers the surface tension of water, thereby controlling mosquito larvae and adult mosquitos by causing them to sink. Even further, in certain embodiments, the water treatment composition has biocidal properties against, e.g., cyanobacteria, thereby facilitating the control of algal growth.

In certain embodiments, mosquito species that can be controlled include, but are not limited to the following genera: Aedeomyia, Aedes, Anopheles, Armigeres, Ayurakitia, Borachinda, Coquillettidia, Culex, Culiseta, Deinocerites, Eretmapodites, Ficalbia, Galindomyia, Ilaemagogus, Heizmannia, Hodgesia, Isostomyia, Isostomyia, Johnbelkinia, Kimia, Limatus, Lutzia, Malaya, Mansonia, Maorigoeldia, Mimomyia, Onirion, Opifex, Orthopodomyia, Psorophora, Runchomyia, Sabethes, Shannoniana, Topomyia, Toxorhynchites, Trichoprosopon, Tripteroides, Udaya, Uranotaenia, Verrallina, and Wyeomyia. In certain preferred embodiments, the mosquitos are of the genera Culex (C. pipiens), Aedes (e.g., A. aegypti, A. albopictus, A. africanus. A. australis, A. rusticus, A polynesiensis), and/or Anopheles (e.g., A. gambiae, A. funestus, A. arabiensis). In certain embodiments, the composition is useful against other biting insects that breed in standing water, such as midges.

In some embodiments, the water treatment composition controls adult mosquitos who land on the standing water, for example, to lay eggs. The water surface tension is reduced such that the mosquito falls beneath the surface and drowns.

In some embodiments, the water treatment composition affects juvenile mosquitos living beneath the surface. Both larva and pupa travel to the water surface frequently to breathe, and pupa eventually emerge from the water as adults; however, in some embodiments, the reduced surface tension prevents case of movement to and from the surface.

In some embodiments, the water treatment composition can be applied to mud or to surfaces of empty containers. There are some mosquitos who lay their eggs in mud or on container edges such that when it rains or the water level increases, the eggs are flooded and can hatch. Thus, in certain embodiments, by preventing the pooling of water in mud, or by applying the composition to empty containers that may fill with water, the composition can help prevent the attachment and/or the hatching of eggs.

In some embodiments, certain species lay their eggs in groups or rafts. In certain embodiments, the composition can destabilize the attachment of the eggs to one another or to other surfaces, thereby reducing any protective advantages that exist as a result of the grouping.

In certain embodiments, the surface active agent is utilized at a concentration, compared with a total amount of water of irrigation liquid being applied, of about 0.001% to about 50%, from about 0.01% to about 25%, from about 0.5% to about 15%, from about 2% to about 12%, from about 3% to about 10%, or any range therein, by weight.

In certain embodiments, the surface active agent is utilized at a concentration, compared with the amount of water or irrigation liquid, at a concentration of about 1 to 1,000 ppm, about 5 to 500 ppm, or about 10 to about 100 ppm.

The pH of the composition should be suitable for the water and soil environment to which it will be applied. In some embodiments, the pH is about 2.0 to about 10.0, about 2.0 to about 9.5, about 2.0 to about 9.0, about 2.0 to about 8.5, about 2.0 to about 8.0, about 2.0 to about 7.5, about 2.0 to about 7.0, about 3.0 to about 7.5, about 4.0 to about 7.5, about 5.0 to about 7.5, about 5.5 to about 7.0, about 6.5 to about 7.5, about 3.0 to about 5.5, about 3.25 to about 4.0, or about 3.5. Buffers, and pH regulators, such as carbonates and phosphates, may be used to stabilize pH near a preferred value.

In certain embodiments, the compositions and methods can be used to enhance the effectiveness and/or reduce the dose of other compounds, for example, by enhancing the penetration of a pesticidal compound into a plant or pest, enhancing the dispersion of the compound, or enhancing the bioavailability of water or nutrients to plant roots. The microbe-based products can also be used to supplement other treatments, for example, insecticide treatments.

The methods and compositions of the subject invention can be used either alone or in combination with other compounds for efficiently mitigating standing water and controlling pests associated therewith. For example, in some embodiments, the method comprises applying additional components, such as herbicides, fertilizers, pesticides and/or other soil amendments, with the water treatment composition. The exact materials and the quantities thereof can be determined by, for example, a grower, soil scientist or entomologist having the benefit of the subject disclosure. In some embodiments, the composition can serve as an adjuvant for a fertilizer, pesticide or herbicide.

In certain embodiments, the subject methods can be further enhanced with the application of one or more microbial inoculants. In certain embodiments, the microbial inoculant comprise one or more soil-colonizing microorganisms and/or growth by-products thereof, such as biosurfactants, enzymes and/or other metabolites. The inoculant composition may also comprise the fermentation medium in which the microorganism(s) were produced.

In certain embodiments, the microorganisms are bacteria, yeasts and/or fungi. In some embodiments, the composition comprises more than one type and/or species of microorganism. In one embodiment, the microorganism is a Bacillus sp. bacterium, such as, e.g., B. mojavensis, B. licheniformis, B. amyloliquefaciens, B. amyloliquefaciens NRRL B-67928, B. subtilis or B. subtilis NRRL B-68031.

In one embodiment, the microorganism is a yeast or fungus, such as, for example, Trichoderma harzianum, Wickerhamomyces anomalus (e.g., NRRL Y-68030), Meyerozyma spp. (e.g., Meyerozyma sp. MEC14XN, M. guilliermondii, M. caribbica, M. caribbica subsp. Locus), Saccharomyces boulardii, Debaryomyces hansenii, Pichia occidentalis and/or Pichia kudriavzevii.

Advantageously, in some embodiments, the microorganism can colonize soil and plant roots and aid in, for example, dispersing water and salts throughout soil, controlling and/or outcompeting pest organisms, solubilizing nutrients for plant root uptake, and/or increasing above and below-ground plant biomass, compared with untreated soils and/or plants.

In one embodiment, the microorganism is B. amyloliquefaciens NRRL B-67928 “B. amy.” A culture of the B. amyloliquefaciens “B. amy” microbe has been deposited with the Agricultural Research Service Northern Regional Research Laboratory (NRRL) Culture Collection, 1815 N. University St., Peoria, IL, USA. The deposit has been assigned accession number NRRL B-67928 by the depository and was deposited on Feb. 26, 2020.

In one embodiment, the microorganism is B. subtilis NRRL B-68031 “B4.” A culture of the B4 microbe has been deposited with the Agricultural Research Service Northern Regional Research Laboratory (NRRL) Culture Collection, 1815 N. University St., Peoria, IL, USA. The deposit has been assigned accession number NRRI B-68031 by the depository and was deposited on May 6, 2021.

In one embodiment, the microorganism is W. anomalus NRRL Y-68030. A culture of this microbe has been deposited with the Agricultural Research Service Northern Regional Research Laboratory (NRRL) Culture Collection, 1815 N. University St., Peoria, IL, USA. The deposit has been assigned accession number NRRL Y-68030 by the depository and was deposited on May 6, 2021.

Each of the subject cultures has been deposited under conditions that assure that access to the culture will be available during the pendency of this patent application to one determined by the Commissioner of Patents and Trademarks to be entitled thereto under 37 CFR § 1.14 and 35 U.S.C. § 122. The deposit is available as required by foreign patent laws in countries wherein counterparts of the subject application, or its progeny, are filed. However, it should be understood that the availability of a deposit does not constitute a license to practice the subject invention in derogation of patent rights granted by governmental action.

Further, the subject culture deposit will be stored and made available to the public in accord with the provisions of the Budapest Treaty for the Deposit of Microorganisms, i.e., it will be stored with all the care necessary to keep it viable and uncontaminated for a period of at least five years after the most recent request for the furnishing of a sample of the deposit, and in any case, for a period of at least 30 (thirty) years after the date of deposit or for the enforceable life of any patent which may issue disclosing the culture. The depositor acknowledges the duty to replace the deposit should the depository be unable to furnish a sample when requested, due to the condition of the deposit. All restrictions on the availability to the public of the subject culture deposit will be irrevocably removed upon the granting of a patent disclosing it.

The microbes and microbe-based compositions of the subject invention have a number of beneficial properties that are useful for, e.g., increasing plant biomass and/or forming/stabilizing carbo-mineral soil aggregates. For example, the compositions can comprise products resulting from the growth of the microorganisms, such as biosurfactants, proteins and/or enzymes, either in purified or crude form. Furthermore, the microorganisms can enhance plant growth, induce auxin production, enable solubilization, absorption and/or balance of nutrients in the soil, and protect plants from pests and pathogens.

In a specific embodiment, the concentration of each microorganism included in the inoculant composition is at least 1×10⁶ to 1×10¹³ CFU/g, 1×10⁷ to 1×10¹² CFU/g, 1×10⁸ to 1×10¹¹ CFU/g, or 1×10⁹ to 1×10¹⁰ CFU/g of the composition.

In one embodiment, the total microbial cell concentration of the inoculant composition is at least 1×10⁶ CFU/g, including up to 1×10⁹ CFU/g, 1×10¹⁰, 1×10¹¹, 1×10¹² and/or 1×10¹³ or more CFU/g. In one embodiment, the microorganisms of the inoculant composition comprise about 5 to 100% of the total composition by weight, or about 8 to 50%, or about 10 to 25%.

The inoculant composition can comprise the leftover fermentation substrate and/or purified or unpurified growth by-products, such as enzymes, biosurfactants and/or other metabolites. The microbes can be live or inactive.

The product of fermentation may be used directly, with or without extraction or purification. If desired, extraction and purification can be easily achieved using standard extraction and/or purification methods or techniques described in the literature.

The microorganisms in the inoculant composition may be in an active or inactive form, or in the form of vegetative cells, reproductive spores, mycelia, hyphae, conidia or any other form of microbial propagule. The composition may also contain a combination of any of these microbial forms.

In one embodiment, when a combination of strains of microorganism are included in the composition, the different strains of microbe are grown separately and then mixed together to produce the composition.

Advantageously, in accordance with the subject invention, the composition may comprise the medium in which the microbes were grown. The composition may be, for example, at least, by weight, 1%, 5%, 10%, 25%, 50%, 75%, or 100% growth medium. The amount of biomass in the composition, by weight, may be, for example, anywhere from 0% to 100% inclusive of all percentages therebetween.

### Growth of Microbes and Production of Biosurfactants According to the Subject Invention

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g., small molecules and proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source can be a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sunflower oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

The pH of the culture should be suitable for the microorganism of interest as well as for the soil environment to which the composition will be applied. In some embodiments, the pH is about 2.0 to about 10.0, about 2.0 to about 9.5, about 2.0 to about 9.0, about 2.0 to about 8.5, about 2.0 to about 8.0, about 2.0 to about 7.5, about 2.0 to about 7.0, about 3.0 to about 7.5, about 4.0 to about 7.5, about 5.0 to about 7.5, about 5.5 to about 7.0, about 6.5 to about 7.5, about 3.0 to about 5.5, about 3.25 to about 4.0, or about 3.5. Buffers, and pH regulators, such as carbonates and phosphates, may be used to stabilize pH near a preferred value.

In one embodiment, the method of cultivation is carried out at about 5° to about 100° C., about 15° to about 60° C., about 20° to about 50° C., about 20° to about 45° C., about 25° to about 40° C., about 25° to about 37° C., about 25° to about 35° C., about 30° to about 35° C., about 24° to about 28° C., or about 22° to about 25° C. In one embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹³, 1×10⁷ to 1×10¹², 1×10⁸ to 1×10¹¹, or 1×10⁹ to 1×10¹⁰ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

Advantageously, the microbe-based products can be produced in remote locations. The microbe growth facilities may operate off the grid by utilizing, for example, solar, wind and/or hydroelectric power.

### Preparation of Microbe-Based Products

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

In one embodiment, the different strains are not mixed together, but are applied to a plant and/or its environment as separate microbe-based products.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

In one embodiment, buffering agents including organic and amino acids or their salts, can be added. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pHI adjusting agents include potassium hydroxide, ammonium hydroxide, potassium carbonate or bicarbonate, hydrochloric acid, nitric acid, sulfuric acid or a mixture.

In one embodiment, additional components such as an aqueous preparation of a salt, such as sodium bicarbonate or carbonate, sodium sulfate, sodium phosphate, sodium biphosphate, can be included in the formulation.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

The subject invention provides compositions for treating standing water, such as retention ponds and puddles, as well as soils prone to flooding and pooling. More specifically, the subject invention provides microbe-derived compositions as well as their use in preventing and/or mitigating, i.e., draining, undesirable standing water and/or problems associated with standing water, such as mosquitos and algal growth. Advantageously, the compositions and methods of the subject invention can be used as environmentally friendly, non-toxic and cost-effective solutions for improving water-use efficiency, enhancing soil health, and controlling pests.

In certain embodiments, the subject invention provides water treatment compositions comprising a surface-active molecule. The water treatment composition can serve multiple purposes, which include:
a) a wetting agent for facilitating the drainage of pooling water into soil;
b) a prophylactic treatment for enhancing the wettability and drainage of soil prior to contact with water such that pooling and flooding are prevented; and
c) a pest control agent, for controlling mosquitos, mosquito larvae and/or algae that are present in stagnant water.

Thus, in certain embodiments, methods are provided wherein the water treatment is applied to natural and artificial sources of standing water and/or soil. In some embodiments, the methods comprise applying the composition to water that is pooling on top of soil, a container of water, such as a water trough, or a body of water, such as a pond. In some embodiments, the methods comprise applying the composition to soil prior to the soil being contacted with irrigation water or rainfall.

Advantageously, in addition to mitigating standing water and/or controlling pests, the methods and compositions are, in some embodiments, effective for improving water-use efficiency and irrigation of soil in a wide variety of conditions, including, for example, compacted soil, arid soil, eroded soil, nutrient-depleted soil, water-logged soil, fire-damaged soil, hydrophobic soil, and/or soil with plants growing therein.

In preferred embodiments, the surface-active molecule of the subject invention is a microbial-derived biosurfactant. The biosurfactant can be applied in purified and/or crude form. Crude form biosurfactants can comprise, for example, biosurfactants and other products of cellular growth, including fermentation medium resulting from cultivation of a biosurfactant-producing microbe.

Biosurfactants according to the subject methods can be selected from, for example, low molecular weight glycolipids (e.g., sophorolipids, cellobiose lipids, rhamnolipids, mannosylerythritol lipids and trehalose lipids), lipopeptides (e.g., surfactin, iturin, fengycin, arthrofactin and lichenysin), flavolipids, phospholipids (e.g., cardiolipins), fatty acid esters, and high molecular weight polymers such as lipoproteins, lipopolysaccharide-protein complexes, and polysaccharide-protein-fatty acid complexes.

In certain specific embodiments, the biosurfactant is a sophorolipid (SLP), such as, for example, a lactonic SLP, an acidic SLP, an amino acid-SLP conjugate, a salt-form SLP, or a derivative of any of these.

In certain embodiments, the water treatment composition can comprise additional substances, such as, for example, carriers, microbial inoculants, pH adjusters, additional pesticides, herbicides, fertilizers, mineral sources, plant seeds, dyes, stabilizers, emulsifiers, prebiotics and/or polymers.

The composition can be applied in combination with an aqueous fluid and administered to the water and/or soil. Additionally, or alternatively, the composition can be applied as a dry form powder or granule, which when mixed with water, activates the surface active molecule within the composition.

In certain embodiments, the water treatment composition is particularly helpful for reducing surface and/or interfacial tension between water and soil, as well as increasing porosity of compacted soils, due to its nanoparticle micelle size. The ultra-small micelle size of the irrigation additive allows water to penetrate into micro- and nano-sized pores in hard and tightly packed soils, thereby loosening the pores and allowing for increased air, nutrient and water flow.

In certain embodiments, the water treatment composition lowers the surface tension of water, thereby facilitating the sinking of mosquito larvae and adult mosquitos in order to control them.

In certain embodiments, the water treatment composition has antimicrobial properties, thereby facilitating the control of algal growth.

The compositions and methods of the subject invention can be useful for farms, pastures, fields, lawns, gardens, golf courses, parks, swamps, ditches, gutters, and any location that is prone to flooding or puddles, has open containers that collect water, or has a body of standing or stagnant water. Advantageously, the compositions and methods of the subject invention provide “green” alternatives to pest control while improving water-use efficiency and soil health.

1. A method of preventing and/or mitigating undesirable standing water, the method comprising applying a composition comprising a surface active molecule to standing water or to soil, wherein said composition lowers the surface tension of the standing water or of water that is contacted with the soil, wherein said surface active molecule is a biosurfactant.

2. The method of claim 1, wherein the biosurfactant has a micelle size less than 25 nm.

3. The method of claim 1, wherein the biosurfactant is selected from glycolipids, lipopeptides, flavolipids, phospholipids, fatty acid esters, lipoproteins, lipopolysaccharide-protein complexes, and polysaccharide-protein-fatty acid complexes.

4. The method of claim 3, wherein the biosurfactant is a sophorolipid.

5. The method of claim 1, wherein the composition is mixed with water and applied to the soil or standing water via an irrigation system.

6. The method of claim 1, wherein the composition is applied to soil before the soil is contacted with water.

7. The method of claim 1, wherein the composition is applied at a concentration of 10 to 100 ppm with respect to the amount of water.

8. The method of claim 1, wherein the composition improves drainage of water into soil, reduces compaction of the soil by penetrating pores within the soil, increases porosity of the soil, and lowers the surface and interfacial tension of the water and soil.

9. The method of claim 1, further comprising applying a microbial soil treatment composition to the soil, wherein the microbial soil treatment composition comprises one or more beneficial microorganisms capable of colonizing soil and/or plant roots.

10. The method of claim 9, wherein the one or more beneficial microorganisms are selected from Trichoderma harzianum, Trichoderma viride, Trichoderma koningii, Trichoderma guizhouse, Bacillus amyloliquefaciens, Bacillus subtilis, Bacillus megaterium, Bacillus polymyxa, Bacillus licheniformis, Brevibacillus laterosporus, Meyerozyma guilliermondii, Meyerozyma caribbica, Pichia occidentalis, Pichia kudriavzevii, Wickerhamomyces anomalus, and Debaryomyces hansenii.

11. The method of claim 9 wherein the beneficial microorganism is Bacillus amyloliquefaciens NRRL B-67928.

12. The method of claim 9, wherein the beneficial microorganism is Wickerhamomyces anomalus NRRL Y-68030.

13. The method of claim 9, wherein the beneficial microorganism is B. subtilis B4 NRRL B-68031.

14. The method of claim 1, wherein the standing water is a puddle, swamp, pond, lake, pool, retention pond or flooded soil.

15. The method of claim 1, further utilized to control a pest that breeds in the standing water.

16. The method of claim 15, wherein the pest is a mosquito, a midge or algae.

17. A method of controlling a pest which comprises applying a composition comprising a biosurfactant to standing water or to soil that will be contacted with water, wherein the pest is a type that breeds in the standing water or soil that will be contacted with water.

18. The method of claim 17, wherein the standing water is present in a man-made container or has collected on a non-soil surface.

19. The method of claim 17, wherein the standing water is a puddle, swamp, pond, lake, pool, retention pond or flooded soil.

20. The method of claim 17, wherein the pest is a mosquito.

21. The method of claim 20, wherein the composition lowers the surface tension of the water, which controls the mosquito by killing adults that visit the water surface to lay eggs, or wherein the composition lowers the surface tension of the water, which prevents mosquito larva and pupa from developing into airborne adults.

22-24. (canceled)

25. The method of claim 17, wherein the surface active molecule is a biosurfactant selected from glycolipids, lipopeptides, flavolipids, phospholipids, fatty acid esters, lipoproteins, lipopolysaccharide-protein complexes, and polysaccharide-protein-fatty acid complexes.

26. The method of claim 25, wherein the biosurfactant is a sophorolipid.
